(19) United States
(12) Patent Application Publication
(10) Pub. No.: US 2026/0274138 A1
(43) Pub. Date: Sep. 17, 2026

(54) VEHICLE SEAT AND MANUFACTURING METHOD THEREFOR

(71) Applicant: TS TECH CO., LTD., Asaka-shi, Saitama (JP)

(72) Inventor: Akira MIYOSHI, Tochigi (JP)

(21) Appl. No.: 19/109,967

(22) PCT Filed: Jul. 30, 2024
(86) PCT No.: PCT/JP2024/027204

§ 371 Date: Mar. 7, 2025

(51) Int. Cl. B60N 2/90; A61H 23/02; B60N 2/64; B60N 2/879

(52) U.S. Cl. CPC B60N 2/976; A61H 23/0263; B60N 2/64; B60N 2/879; A61H 2201/0149; A61H 2201/1215

(57) ABSTRACT

The vehicle seat includes a seat cushion and a seat back extending upward from a rear part of the seat cushion. The seat back includes a frame forming a skeletal structure, a pad supported by the frame, a skin material covering the pad, and a plurality of air cells and a plurality of vibrators provided on the pad. The vibrators and the air cells are placed so as not to overlap with one another.

### TECHNICAL FIELD

The present invention relates to a vehicle seat.

### BACKGROUND ART

Patent Document 1 discloses a vehicle seat provided with a plurality of vibrators. The vibrators are controlled to vibrate based on route guidance information. As a result, the driver seated in the vehicle seat can recognize the route guidance information from the vibration caused by the vibrators. Patent Document 1 also discloses another vehicle seat fitted with a plurality of air cells which can be inflated by receiving a supply of compressed air. The passenger seated in the vehicle seat is massaged by the expansion and contraction of the air cells.

### PRIOR ART DOCUMENT(S)

### Patent Document(s)

Patent Document 1: JP2021-123159A

### SUMMARY OF THE INVENTION

### Task to be Accomplished by the Invention

When vibrators and air cells are arranged on a common seat, there is a risk that the vibrators and the air cells may adversely interfere with each other. For example, there is a risk that the vibration of the vibrators may be absorbed by the air cells, preventing the vibration to be transmitted to the seated person.

In view of the above background, a primary task of the present invention is to provide a vehicle seat that allows vibrators and air cells installed in the vehicle seat to fully perform their respective functions.

### Means to Accomplish the Task

To accomplish such a task, an aspect of the present invention provides a vehicle seat (1), comprising a seat cushion (3) and a seat back (4) extending upward from a rear part of the seat cushion, the seat back comprising a frame (21) forming a skeletal structure, a pad (22) supported by the frame, a skin material (23) covering the pad, and a plurality of air cells (71) and a plurality of vibrators (72) provided on the pad, wherein the pad includes a lateral central part (22A) and a pair of side support parts (22B) protruding forward from either side end of the central part, and wherein some of the vibrators and some of the air cells are placed on front surfaces of the left and right side support parts such that the air cells are vertically displaced from the vibrators.

According to this aspect, some of the vibrators and some of the air cells are placed in the side support parts. Since the vibrators and the air cells are spaced apart from each other in the side support parts, the vibrators and the air cells can fully perform their respective functions in the vehicle seat.

In the above aspect, preferably, an electronic control device (81) that controls the vibrators is positioned behind a lower end part of at least one of the left and right side support parts.

According to this aspect, the electronic control device is positioned remotely from the back of the seated occupant so that the electronic control device is prevented from abutting against the back of the seated occupant.

In the above aspect, preferably, a plurality of sensors (601) is provided between a front surface of the pad and the skin material, the front surfaces of the left and right side support parts being each provided with at least one of the sensors, and the vibrators, the air cells, and the sensor are vertically spaced from one another.

According to this aspect, each sensor is made less susceptible to the effects of the vibrators and the air cells so that the sensor's detection capability is prevented from being impaired.

In the above aspect, preferably, a headrest (5) is provided at an upper end of the seat back, and at least one of the vibrators, at least one of the air cells, and at least one of the sensors are provided in a front part of the headrest.

According to this aspect, the functionality of the headrest can be improved.

In the above aspect, preferably, the skin material is secured to a front surface the pad by a plurality of engaging portions (53), and the sensors are positioned adjacent to the engaging portions.

According to this aspect, the sensor's detection accuracy can be prevented from being diminished. Since the parts of the skin material adjacent to the engaging portions are restricted from moving by the engaging portions, the movement of the skin material is prevented from adversely affecting the sensors.

In the above aspect, preferably, the pad is provided with a plurality of locking grooves (52) for pulling the skin material therein on a front surface thereof, the engaging portions are positioned within the locking grooves, and the sensors are positioned along at least one of the locking grooves.

According to this aspect, the detection accuracy of the sensors is prevented from being impaired. Since the parts of the skin material adjacent to the locking grooves are restricted from moving by the engaging portions, the movement of the skin material is prevented from adversely affecting the sensors.

In the above aspect, preferably, the locking grooves include a plurality of longitudinal locking grooves (52A) extending in a vertical direction and a plurality of lateral locking grooves (52B) extending in a horizontal direction, and at least some of the sensors are positioned adjacent to intersections (52C) of the longitudinal locking groove and the lateral locking grooves.

According to this aspect, impairment of the detection accuracy of the sensor can be prevented. Since the movement of the skin material is restricted by the engaging portions in regions adjacent thereto, the movement of the skin material is prevented from adversely affecting the sensors.

In the above aspect, preferably, the sensors, the air cells, and the vibrators are arranged in this order from top along one of the longitudinal locking grooves under one of the lateral locking grooves.

According to this aspect, the sensors, the air cells, and the vibrators can be arranged efficiently.

In the above aspect, preferably, the air cells are each formed in an annular shape and provided with a central hole (71B) in which the corresponding vibrator is located.

According to this aspect, each air cell and the corresponding vibrator can be arranged compactly without interfering with each other.

Another aspect of the present invention provides a method for manufacturing a vehicle seat (1) having a seat cushion (3) and a seat back (4), the method comprising the steps of: causing a pad (22) to be supported on a frame (21) of the seat back; positioning a plurality of air cells (71) and a plurality of vibrators (72) on a front surface of the pad such that the vibrators and the air cells do not overlap with one another when viewed from front, and covering the pad with a skin material (23).

According to this aspect, the vehicle seat can be manufactured in such a manner that the vibrators and the air cells can perform their respective functions properly.

### Effect of the Invention

An aspect of the present invention provides a vehicle seat (1), comprising a seat cushion (3) and a seat back (4) extending upward from a rear part of the seat cushion, the seat back comprising a frame (21) forming a skeletal structure, a pad (22) supported by the frame, a skin material (23) covering the pad, and a plurality of air cells (71) and a plurality of vibrators (72) provided on the pad, wherein the pad includes a lateral central part (22A) and a pair of side support parts (22B) protruding forward from either side end of the central part, and wherein some of the vibrators and some of the air cells are placed on front surfaces of the left and right side support parts such that the air cells are vertically displaced from the vibrators.

According to this aspect, some of the vibrators and some of the air cells are placed in the side support parts. Since the vibrators and the air cells are spaced apart from each other in the side support parts, the vibrators and the air cells can fully perform their respective functions in the vehicle seat.

In the above aspect, preferably, an electronic control device (81) that controls the vibrators is positioned behind a lower end part of at least one of the left and right side support parts.

According to this aspect, the electronic control device is positioned remotely from the back of the seated occupant so that the electronic control device is prevented from abutting against the back of the seated occupant.

In the above aspect, preferably, a plurality of sensors (601) is provided between a front surface of the pad and the skin material, the front surfaces of the left and right side support parts being each provided with at least one of the sensors, and the vibrators, the air cells, and the sensor are vertically spaced from one another.

According to this aspect, each sensor is made less susceptible to the effects of the vibrators and the air cells so that the sensor's detection capability is prevented from being impaired.

In the above aspect, preferably, a headrest (5) is provided at an upper end of the seat back, and at least one of the vibrators, at least one of the air cells, and at least one of the sensors are provided in a front part of the headrest.

According to this aspect, the functionality of the headrest can be improved.

In the above aspect, preferably, the skin material is secured to a front surface the pad by a plurality of engaging portions (53), and the sensors are positioned adjacent to the engaging portions.

According to this aspect, the sensor's detection accuracy can be prevented from being diminished. Since the parts of the skin material adjacent to the engaging portions are restricted from moving by the engaging portions, the movement of the skin material is prevented from adversely affecting the sensors.

In the above aspect, preferably, the pad is provided with a plurality of locking grooves (52) for pulling the skin material therein on a front surface thereof, the engaging portions are positioned within the locking grooves, and the sensors are positioned along at least one of the locking grooves.

According to this aspect, the detection accuracy of the sensors is prevented from being impaired. Since the parts of the skin material adjacent to the locking grooves are restricted from moving by the engaging portions, the movement of the skin material is prevented from adversely affecting the sensors.

In the above aspect, preferably, the locking grooves include a plurality of longitudinal locking grooves (52A) extending in a vertical direction and a plurality of lateral locking grooves (52B) extending in a horizontal direction, and at least some of the sensors are positioned adjacent to intersections (52C) of the longitudinal locking groove and the lateral locking grooves.

According to this aspect, impairment of the detection accuracy of the sensor can be prevented. Since the movement of the skin material is restricted by the engaging portions in regions adjacent thereto, the movement of the skin material is prevented from adversely affecting the sensors.

In the above aspect, preferably, the sensors, the air cells, and the vibrators are arranged in this order from top along one of the longitudinal locking grooves under one of the lateral locking grooves.

According to this aspect, the sensors, the air cells, and the vibrators can be arranged efficiently.

In the above aspect, preferably, the air cells are each formed in an annular shape and provided with a central hole (71B) in which the corresponding vibrator is located.

According to this aspect, each air cell and the corresponding vibrator can be arranged compactly without interfering with each other.

Another aspect of the present invention provides a method for manufacturing a vehicle seat (1) having a seat cushion (3) and a seat back (4), the method comprising the steps of: causing a pad (22) to be supported on a frame (21) of the seat back; positioning a plurality of air cells (71) and a plurality of vibrators (72) on a front surface of the pad such that the vibrators and the air cells do not overlap with one another when viewed from front, and covering the pad with a skin material (23).

According to this aspect, the vehicle seat can be manufactured in such a manner that the vibrators and the air cells can perform their respective functions properly.

### BRIEF DESCRIPTION OF THE DRAWINGS

FIG. 1 A perspective view of a seat according to a first embodiment of the present invention

FIG. 2 A perspective view of a seat frame

FIG. 3 A horizontal sectional view of a seat back

FIG. 4 An explanatory diagram of the seat back as viewed from the front

FIG. 5 A block diagram showing various components of the seat back

FIG. 6 A vertical sectional view of the seat back

FIG. 7 An explanatory diagram of the seat back according to a modification of the first embodiment as viewed from the front

FIG. 8 An explanatory diagram of a seat back according to a second embodiment of the present invention as viewed from the front

FIG. 9 An explanatory diagram of a seat back according to a third embodiment of the present invention as viewed from the front

FIG. 10 An explanatory diagram of a seat back according to a fourth embodiment of the present invention as viewed from the front

FIG. 11 An explanatory diagram of a seat back according to a fifth embodiment of the present invention as viewed from the front

FIG. 12 An explanatory diagram of a seat back according to a sixth embodiment of the present invention as viewed from the front

FIG. 13 An explanatory diagram of a seat back according to a seventh embodiment of the present invention as viewed from the front

FIG. 14 A horizontal sectional view of the seat back of the seventh embodiment

FIG. 15 A horizontal sectional view of a seat back according to a modification of the seventh embodiment

FIG. 16 An explanatory diagram of a seat back according to an eighth embodiment of the present invention as viewed from the front

FIG. 17 An explanatory diagram of a seat back according to a ninth embodiment of the present invention as viewed from the front

### DETAILED DESCRIPTION OF THE PREFERRED EMBODIMENT(S)

### First Embodiment

A vehicle seat according to an embodiment of the present invention as applied to a car will be described in the following with reference to the appended drawings. In the following description, various directions such as front/rear, left/right, and up/down will be defined based on the vehicle in which the seat is installed.

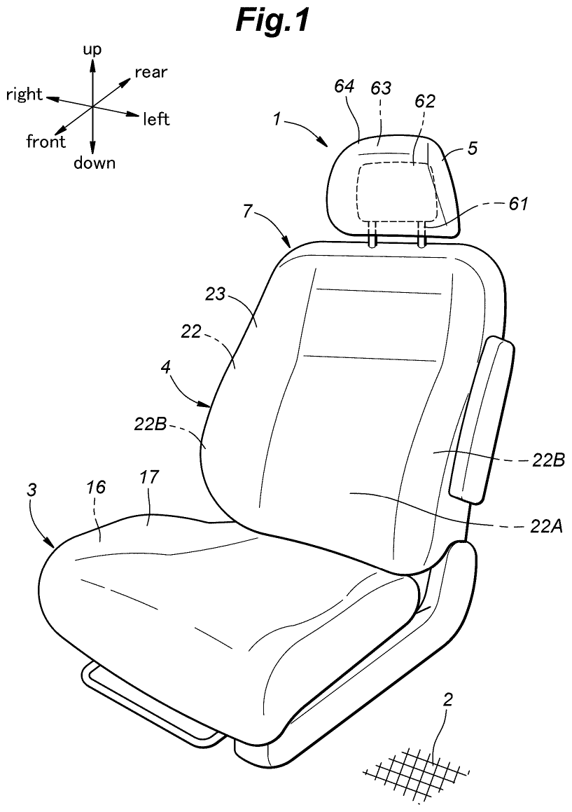

As shown in FIG. 1, the seat 1 includes a seat cushion 3 provided on a floor 2, a seat back 4 extending upward from a rear part of the seat cushion 3, and a headrest 5 connected to the upper end of the seat back 4. The seat back 4 is rotatably supported by the seat cushion 3. The seat cushion 3, the seat back 4, and the headrest 5 constitute a seat main body 7. The seat cushion 3 supports the buttocks of the occupant, and the seat back 4 supports the back of the occupant.

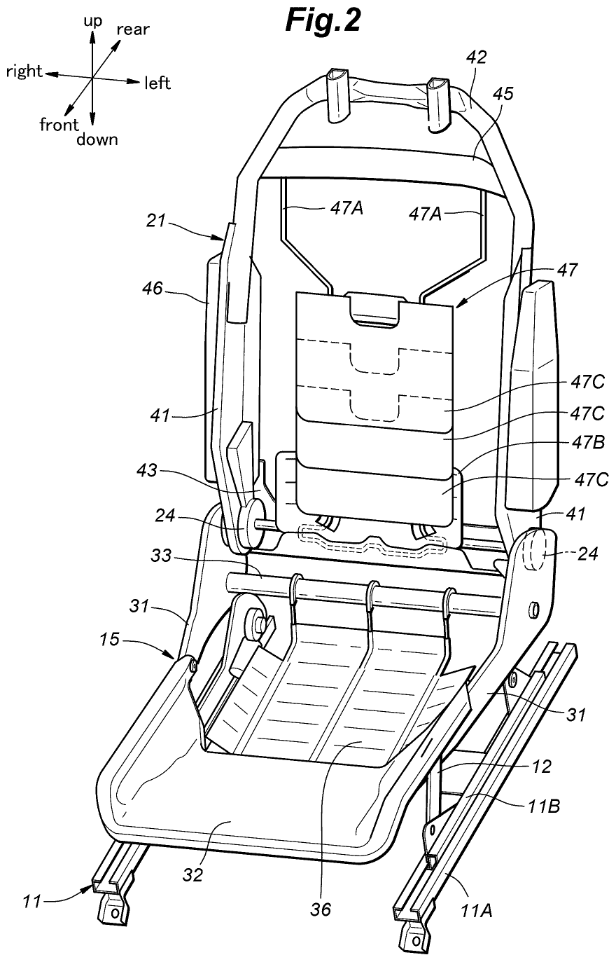

As shown in FIG. 2, the seat cushion 3 is provided on the floor 2 via a slide rail device 11. The slide rail device 11 includes a pair of lower rails 11A attached to the floor 2 on either side and a pair of upper rails 11B supported on the lower rails 11A, respectively, so as to be slidable. The seat cushion 3 is connected to the upper rails 11B. A lifting device 12 may be interposed between the seat cushion 3 and the upper rails 11B. The lifting device 12 supports the seat cushion 3 so as to be liftable relative to the upper rails 11B.

The seat cushion 3 includes a seat cushion frame 15 forming a skeletal structure, a seat cushion pad 16 supported by the seat cushion frame 15, and a skin material 17 covering the surface of the seat cushion pad 16. The seat back 4 has a seat back frame 21 forming a skeletal structure, a seat back pad 22 supported by the seat back frame 21, and a skin material 23 covering the surface of the seat back pad 22. The seat cushion frame 15 and the seat back frame 21 are connected to each other via a reclining device 24.

The seat cushion frame 15 is formed in a rectangular frame shape. The seat cushion frame 15 includes a pair of seat cushion side members 31 extending in the fore and aft direction on either side, a front member 32 extending laterally and connected between the front ends of the cushion side members 31, and a rear member 33 extending laterally and connected between the rear ends of the seat cushion side members 31. The front member 32 is preferably a pan frame formed in a plate shape. A flexible pressure receiving member 36 is spanned between the front member 32 and the rear member 33. The pressure receiving member 36 supports the buttocks of the occupant from below.

The seat back frame 21 is formed in a rectangular frame shape. The seat back frame 21 includes a pair of seat back side members 41 extending vertically on either side, an upper member 42 extending horizontally and connected between the upper ends of the left and right seat back side members 41, and a lower member 43 extending horizontally and connected between the lower ends of the left and right seat back side members 41. The left and right seat back side members 41 are formed of sheet metal members. The upper member 42 is formed of a metal pipe. The upper member 42 is curved so that the lateral central part thereof is upwardly convex. The left and right ends of the upper member 42 are connected to the upper ends of the left and right seat back side members 41, respectively.

The seat back frame 21 further includes a cross member 45 extending horizontally below the upper member 42 and connected between the left and right ends of the upper member 42. The cross member 45 is formed of a sheet metal member. In other embodiments, the left and right ends of the cross member 45 may be connected to the left and right seat back side members 41. The cross member 45 supports the occupant's shoulders from the rear. A side airbag unit 46 may be provided on the laterally outer surface of at least one of the left and right seat back side members 41.

The seat back frame 21 is provided with a back pressure receiving portion 47 for supporting the occupant's back. The back pressure receiving portion 47 is spanned between the cross member 45 and the lower member 43. The back pressure receiving portion 47 includes a pair of wires 47A spanned between the cross member 45 and the lower member 43, a resin plate 47B supported by the wires 47A, and a plurality of air cells 47C supported by the resin plate 47B. The resin plate 47B is connected to the lower parts of the left and right wires 47A and faces forward. A plurality of air cells 47C is placed on the front surface of the resin plate 47B. The air cells 47C can be inflated and change the shape of the back pressure receiving portion 47 by receiving a supply of air.

The seat back pad 22 is supported by the seat back frame 21 and the back pressure receiving portion 47. The seat cushion pad 16 is supported by the seat cushion frame 15 and the pressure receiving member 36.

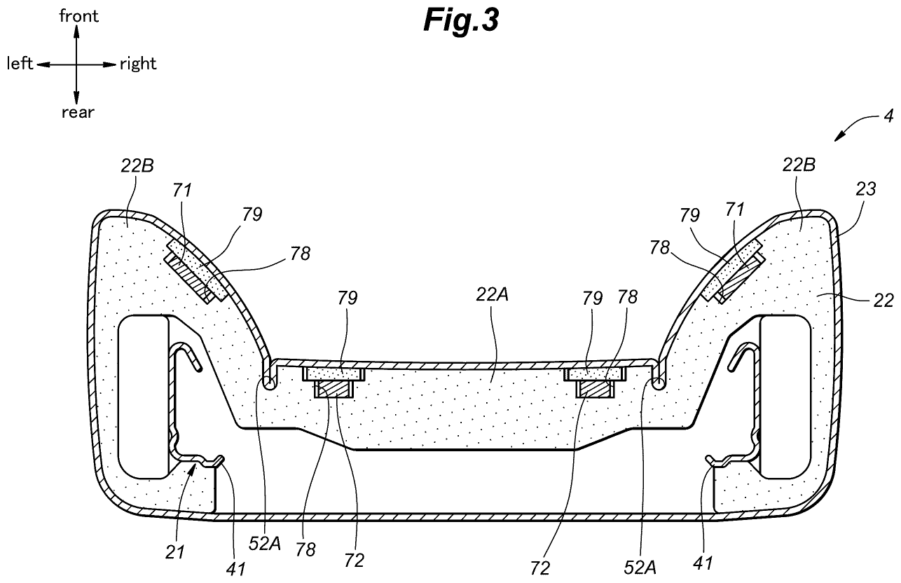

As shown in FIG. 3, the seat back pad 22 includes a central part 22A in a lateral central part thereof and a pair of side support parts 22B protruding forward from the left and right ends of the central part 22A, respectively. The central part 22A and the left and right side support parts 22B extend in the vertical direction. The left and right side support parts 22B against the left and right sides of the occupant's back, thereby guiding the occupant's back toward the central part 22A.

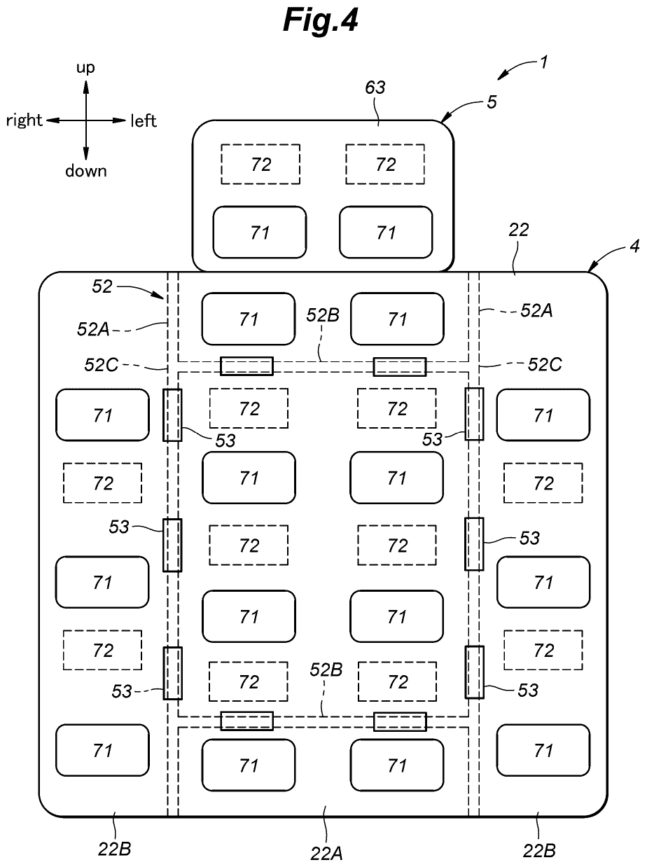

As shown in FIG. 3 and FIG. 4, the front surface of the seat back pad 22 is provided with a plurality of locking grooves 52 for pulling down the skin material 23 therein. The locking grooves 52 include a plurality of longitudinal locking grooves 52A extending in the vertical direction and a plurality of lateral locking grooves 52B extending in the horizontal direction. The longitudinal locking grooves 52A may be provided at the boundaries between the central part 22A and the left and right side support parts 22B. The lateral locking grooves 52B may be provided at intervals along the vertical direction in the central part 22A. The lateral locking grooves 52B are connected to the longitudinal locking grooves 52A to form intersections 52C.

The skin material 23 is engaged to the front surface of the seat back pad 22 by a plurality of engaging portions 53. The engaging portions 53 engage engaged portions provided on the back surface of the skin material 23. The engaged portions may consist of trim cords connected to tabs provided on the skin material 23. The trim cords may be rod-shaped members made of resin and extending linearly. The engaging portions 53 may be resin clips that engage the trim cords. The engaging portions 53 may be positioned in the locking grooves 52. The engaging portions 53 may be positioned in the longitudinal locking grooves 52A and the lateral locking grooves 52B. The engaging portions 53 may be embedded in the locking grooves 52 by insert molding. The edges of the skin material 23 may be connected to each other by a zipper or the like at the rear of the seat back 4. The edges of the skin material 23 may also be hooked to the seat back frame 21 at the rear of the seat back 4.

As shown in FIG. 1, the headrest 5 includes a pair of pillars 61 supported by the upper member 42, a headrest core 62 supported by the pillars 61, a flexible headrest pad 63 supported by the headrest core 62, and a skin material 64 that covers the headrest pad 63. The headrest core 62 may be formed of a resin material or a metal plate.

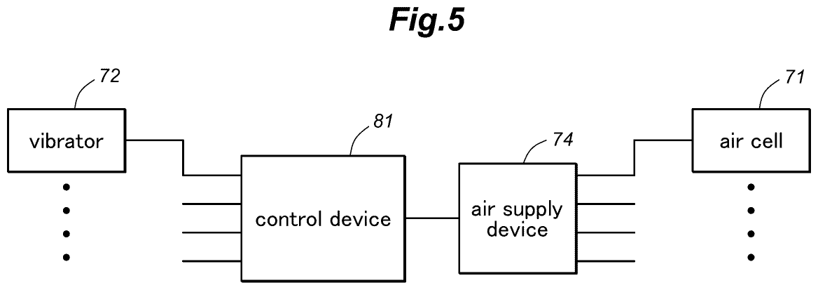

As shown in FIGS. 4 and 5, the seat back pad 22 is provided with a plurality of air cells 71 and a plurality of vibrators 72. Each air cell 71 is connected to an air supply device 74. Each air cell 71 is inflated by receiving compressed air from the air supply device 74. The air supply device 74 includes a compressor that compresses air and a plurality of control valves that control the supply of the compressed air from the compressor to each air cell 71. The air supply device 74 may be located inside the seat cushion 3 or the seat back 4 or may be located on the floor 2. For example, the air supply device 74 may be positioned between the floor 2 and the seat cushion 3.

The air cells 71 change the shape of the front surface of the seat back 4 by inflating and deflating independently of one another. This makes it possible to correct the posture of the seated person. The air cells 71 can massage the seated occupant by expanding and contracting. Each air cell 71 is also provided with a pressure sensor that measures the internal pressure thereof. Based on the internal pressure of each air cell 71, the distribution of the pressure applied by the seated occupant to the seat back 4 can be obtained, and the posture of the seated occupant can be detected based on the pressure distribution.

Each vibrator 72 may include an electric motor and an eccentric weight rotated by the electric motor. Each vibrator 72 may also include an electromagnet and a magnet serving as a weight that is moved by the magnetic force generated by the electromagnet. Each vibrator 72 can stimulate the back of the seated occupant by vibrating and can alert the seated occupant for caution or warning.

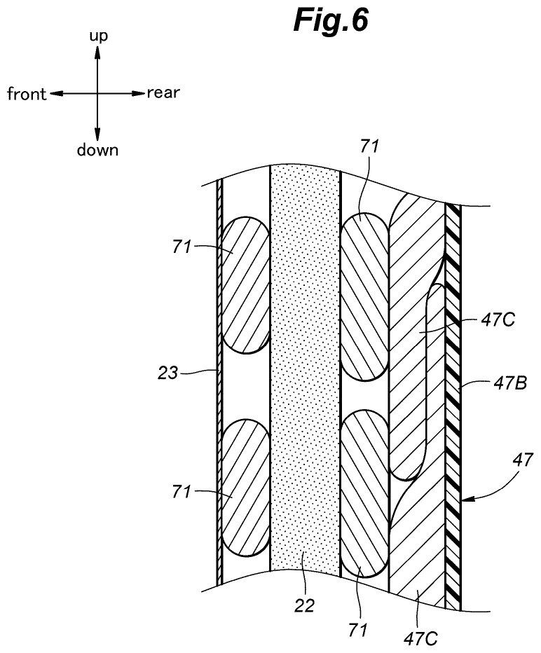

As shown in FIG. 4, the air cells 71 and the vibrators 72 are placed between the front surface of the seat back pad 22 and the skin material 23. The air cells 71 and the vibrators 72 may be housed in individual recesses 78 formed in the front surface of the seat back pad 22. Each recess 78 may be fitted with a flexible lid plate 79 that is positioned in front of the air cell 71 or the vibrator 72 housed in the particular recess 78 so as to close the recess 78. As shown in FIG. 6, the air cells 71 may also be provided on the rear surface of the seat back pad 22. The air cells 71 may be provided between the rear surface of the seat back pad 22 and the back pressure receiving portion 47.

As shown in FIG. 4, the air cells 71 and the vibrators 72 may be provided in the headrest 5. The air cells 71 and the vibrators 72 are provided between the front surface of the headrest pad 63 and the skin material 64. In another embodiment, the air cells 71 and the vibrators 72 may be received in recesses formed in the front surface of the headrest pad 63. A flexible lid plate may be provided in front of the air cell 71 or the vibrator 72 accommodated in each recess so as to close the recess. The air cells 71 and the vibrators 72 may also be provided between the headrest pad 63 and the headrest core 62.

As shown in FIG. 5, the vibrators 72 and the air supply device 74 are connected to the control device 81. The control device 81 is an electronic control device containing a processor and memory communicably connected to the processor. The processor may include at least one of a central processing unit (CPU), a graphics processing unit (GPU), and a reduced instruction set computer (RISC) as a core component. The memory may include at least one of volatile memory and non-volatile memory. The volatile memory may be dynamic random access memory (DRAM) or static random access memory (SRAM). The non-volatile memory may be a solid state drive (SSD), flash memory, a magnetic disk storage device, or an optical disk storage device. At least a part of the control device 81 may be realized by hardware such as an LSI, an ASIC, or an FPGA, or may be realized by a combination of software and hardware. The processor realizes various applications by executing a program stored in the memory. The program may be stored in the memory or may be stored in a removable storage medium such as a DVD or a CD-ROM, and may be installed in the memory by reading the storage medium with a reading device. The program may also be downloaded and installed in the memory via a communication network such as the Internet. The control device 81 may be configured with a single piece of hardware or may be configured with multiple pieces of hardware capable of communicating with one another.

The control device 81 controls the air supply device 74 so as to control the inflation and deflation of the air cells 71. This allows the air cells 71 to massage the seated occupant or correct the seated occupant's posture. The control device 81 also determines the posture of the occupant based on the internal pressures of the air cells 71. The control device 81 also notifies the seated occupant of various kinds of information by operating the vibrators 72.

As shown in FIG. 4, the vibrators 72 and the air cells 71 are arranged so that they do not overlap with each other when viewed from the front. Some of the vibrators 72 and some of the air cells 71 are positioned on the front surfaces of the left and right side support parts 22B. Also, some of the vibrators 72 and some of the air cells 71 are positioned on the front surface of the central part 22A.

On the front surface of each side support part 22B, the vibrators 72 and the air cells 71 are arranged vertically and spaced apart from each other. On the front surface of each side support part 22B, the vibrators 72 and the multiple air cells 71 are arranged in a single vertical row. Also, on the front surface of each side support part 22B, the vibrators 72 and the air cells 71 are arranged alternately. On the front surface of the central part 22A, the vibrators 72 and the air cells 71 are arranged in two vertical rows. Also, on the front surface of the central part 22A, the vibrators 72 and the air cells 71 are arranged alternately in the vertical direction.

On the headrest 5, the vibrators 72 and the air cells 71 are arranged so that they do not overlap each other when viewed from the front. On the front surface of the headrest 5, the vibrators 72 and the air cells 71 are arranged in two vertical rows. Furthermore, on the headrest 5, the vibrators 72 and the air cells 71 are arranged alternately in the vertical direction.

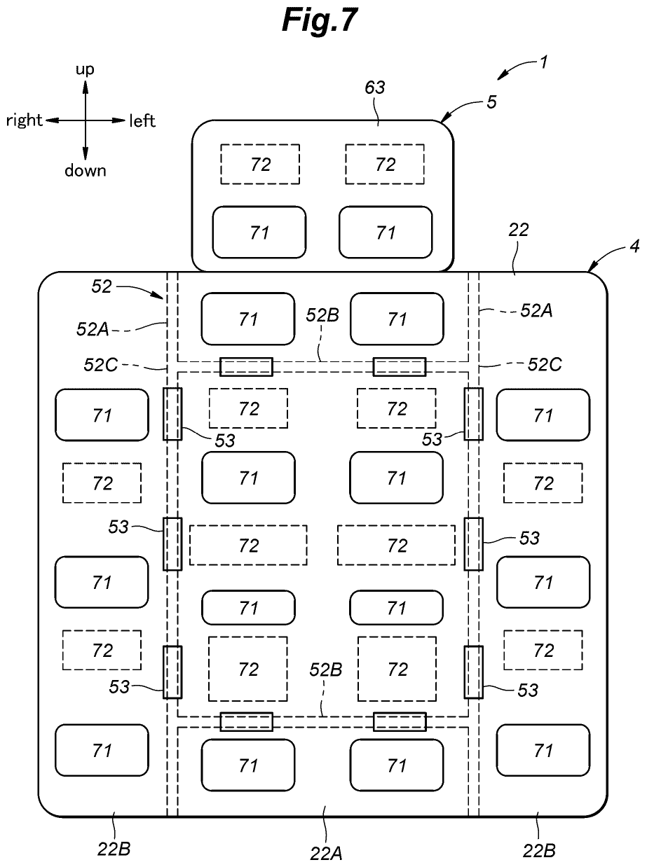

As shown in FIG. 7, the length of each vibrator 72 in the lateral direction may be greater than the length of each air cell 71 in the lateral direction. Furthermore, the length of each vibrator 72 in the vertical direction may be greater than the length of each air cell 71 in the vertical direction. This allows the vibration of the vibrators 72 to be transmitted to the seated person in a more efficient manner.

The length of each air cell 71 in the lateral direction may be greater than the length of each vibrator 72 in the lateral direction. Furthermore, the length of each air cell 71 in the vertical direction may be greater than the length of each vibrator 72 in the vertical direction. As a result, posture detection and posture correction by the air cells 71 can be performed in a more stable manner. The air cells 71 can also massage the seated person more effectively.

In the above-mentioned seat 1, the vibrators 72 and the air cells 71 are arranged so as not to overlap with one another when viewed from the front, so that the air cells 71 are prevented from absorbing the vibration of the vibrators 72. This allows the vibrators 72 and the air cells 71 to perform the respective functions thereof properly. In other words, the vibrators 72 and the air cells 71 are prevented from adversely affecting one another.

The manufacturing method of the seat 1 includes the step of supporting the seat back pad 22 on the seat back frame 21 of the seat back 4, the step of arranging the air cells 71 and the vibrators 72 on the front surface of the seat back pad 22, and the step of covering the seat back pad 22 with the skin material 23. In the process of arranging the air cells 71 and the vibrators 72, the air cells 71 and the vibrators 72 are arranged so that the vibrators 72 and the air cells 71 do not overlap each other when viewed from the front.

### Second Embodiment

The seat 200 according to a second embodiment of the present invention differs from the seat 1 of the first embodiment in the shape of the air cells 71 and the positioning of the air cells 71 and the vibrators 72. The configuration of the seat 200 of the second embodiment is otherwise the same as that of the seat 1 of the first embodiment.

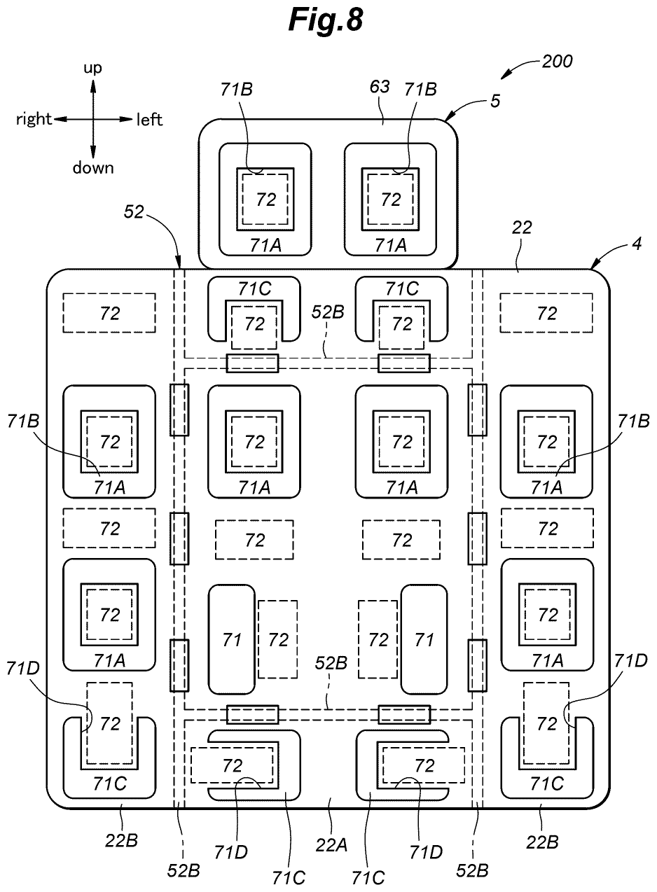

As shown in FIG. 8, the air cells 71 include annular air cells 71A formed in an annular shape. Each annular air cell 71A defines a central hole 71B which is preferably open toward the front and rear. The annular air cells 71A are preferably arranged in the central part 22A, the left and right side support parts 22B, and the headrest 5. The central hole 71B of the annular air cell 71A each preferably receives a vibrator 72 therein.

The air cells 71 include air cells 71C formed in a C-shape. Each air cell 71C formed in a C-shape defines an inner hole 71D which is open toward the front and rear. The annular air cells 71A may be positioned in the central part 22A, the left and right side support parts 22B, and the headrest 5. The inner hole 71D of each C-shaped air cell 71C receives a vibrator 72 therein. A part of the vibrator 72 in the inner hole 71D of each air cell 71C may protrude to the outside thereof.

Some of the air cells 71 may each be positioned next to a vibrator 72.

In the seat 1 of the second embodiment, the vibrators 72 and the air cells 71 are positioned so as not to overlap with one another when viewed from the front, so that the air cells 71 are prevented from absorbing the vibrations of the vibrators 72. This allows the vibrators 72 and the air cells 71 to properly perform their respective functions.

### Third Embodiment

The seat 300 according to a third embodiment of the present invention differs from the seat 1 of the first embodiment in that it is additionally provided with a plurality of heaters 301 and a plurality of speakers 302. The configuration of the seat 300 of the third embodiment is otherwise the same as that of the seat 1 of the first embodiment.

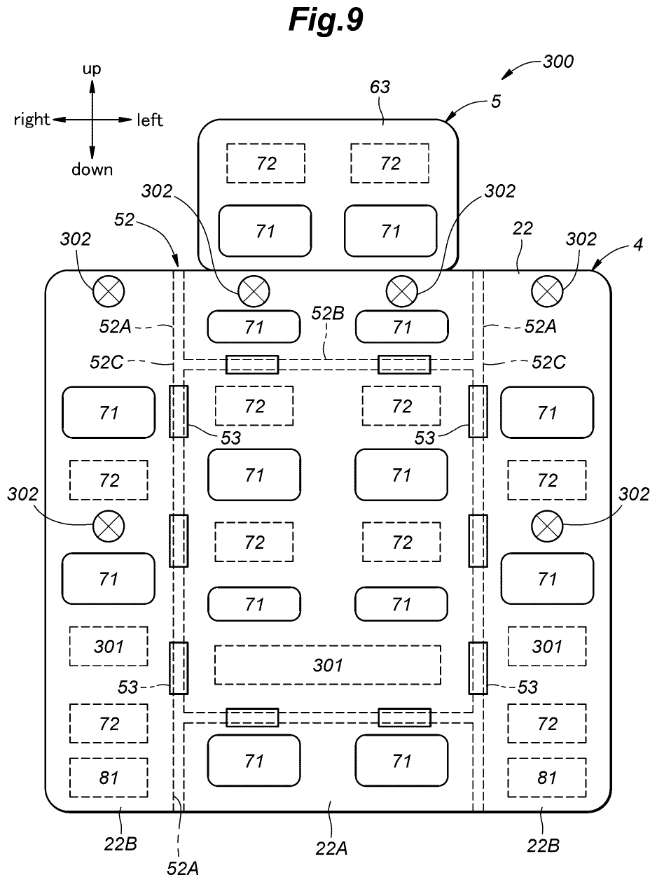

As shown in FIG. 9, the speakers 302 and the heaters 301 are arranged so as not to overlap with the vibrators 72 and the air cells 71 when viewed from the front. The speakers 302 may be provided in an upper end part of the front surface of the central part 22A and at upper end parts of the front surfaces of the left and right side support parts 22B. The speakers 302 each functioning as an acoustic device may also be provided in a vertically central parts of the front surfaces of the left and right side support parts 22B. The speakers 302 may be placed in individual recesses 78 formed in the front surface of the central part 22A and the left and right side support parts 22B.

Each heater 301 is formed in a sheet shape. Each heater 301 includes a sheet-like member such as nonwoven fabric and a heating wire attached to the surface of the sheet-like member. Each heater 301 is positioned between the front surface of the seat back pad 22 and the skin material 23. The lateral length of the heater 301 may be greater than the lateral length of the air cells 71 and the lateral length of the vibrators 72. The heaters 301 are located in the central part 22A and the left and right side support parts 22B.

The control device 81 controls the heaters 301 and the speakers 302. The control device 81 may be placed behind the lower end of at least one of the left and right side support parts 22B. When viewed from the front, the control device 81 is positioned so as not to overlap any of the vibrators 72 and the air cells 71.

On the front surface of each of the side support parts 22B, the vibrators 72, the air cells 71, the speakers 302, and the heaters 301 are positioned in a vertical row spaced apart from each other.

### Fourth Embodiment

The seat 400 according to a fourth embodiment of the present invention is different from the seat 300 of the third embodiment in that an air conditioning device 401 is additionally provided. The configuration of the seat 400 of the fourth embodiment is otherwise the same as that of the seat 1 of the first embodiment.

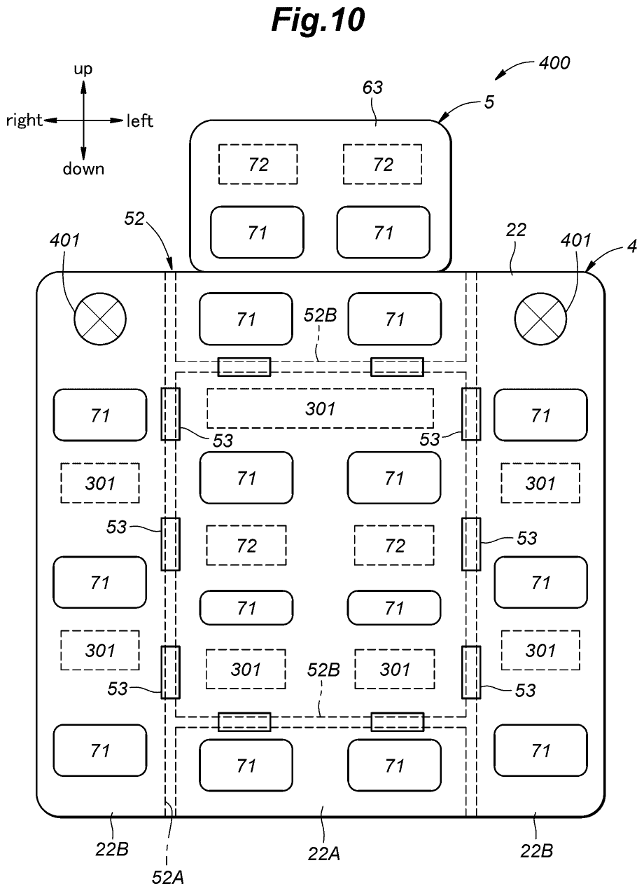

As shown in FIG. 10, a plurality of heaters 301 are provided in the central part 22A. The heaters 301 provided in the central part 22A may include those having different lateral lengths. A plurality of heaters 301 is provided in each of the left and right side support parts 22B. A speaker 302 is provided at an upper end part of each side support part. In addition, an air conditioning device 401 is provided at an upper end part of each side support part 22B. The air conditioning devices 401 may each consist of a blower.

### Fifth Embodiment

The seat 500 according to a fifth embodiment of the present invention is different from the seat 1 of the first embodiment in that an air conditioning device 501 is provided. The configuration of the seat 500 of the fifth embodiment is otherwise the same as that of the seat 1 of the first embodiment.

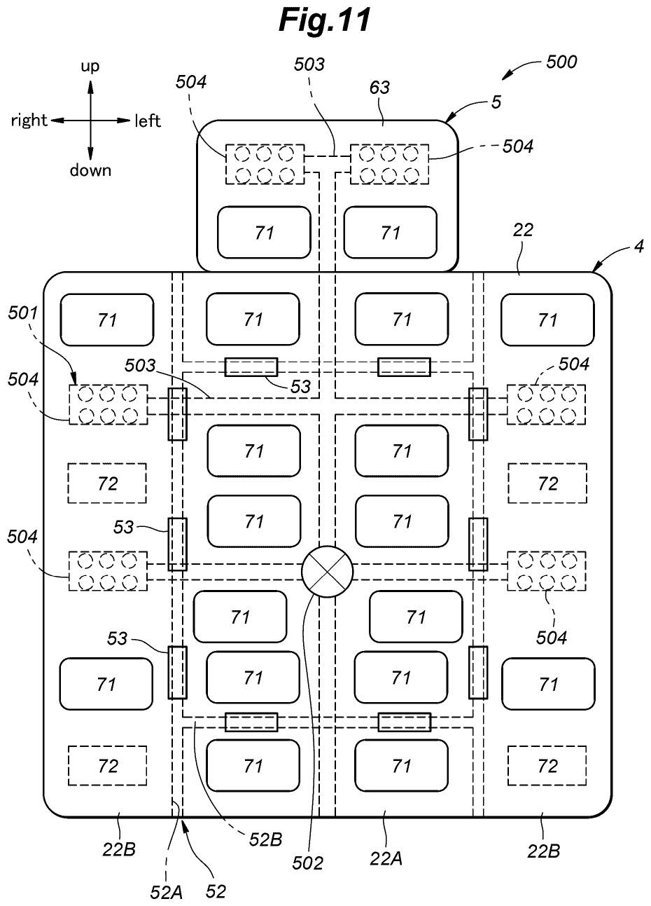

As shown in FIG. 11, the air conditioning device 501 includes at least one blower 502, a plurality of air passages 503, and a plurality of air openings 504. The blower 502 may be provided on the rear surface of the seat back pad 22. The air passages 503 are formed inside the seat back pad 22. For example, a plurality of air grooves may be formed on the front surface of the seat back pad 22, and a plurality of cover pads may be placed thereon to cover the air grooves, thereby forming the air passages 503. The air passages 503 are connected to the blower 502. The air openings 504 are communicated with the air passages 503 and open to the front surface of the seat back 4. When the blower 502 is driven, air is discharged from the air openings 504 via the air passages 503. In another embodiment, the blower 502 may be operated so that air is drawn from the air openings 504 into the air passages 503.

When viewed from the front, the air conditioning device 501 is preferably placed so as not to overlap with the vibrators 72 and the air cells 71. In particular, the blower 502 or blowers, the air passages 503, and the air openings 504 are preferably positioned so as not to overlap with the vibrators 72 and the air cells 71. When viewed from the front, the blower 502 is preferably positioned in the center of the central part 22A. Also, a blower 502 may be provided in the headrest 5. When the seat back pad 22 and the headrest pad 63 are integrally formed, the air passages 503 are preferably extended from the seat back pad 22 to the headrest pad 63.

### Sixth Embodiment

The seat 600 according to a sixth embodiment of the present invention is different from the seat 300 of the third embodiment in that a plurality of sensors 601 are provided. The configuration of the seat 600 of the sixth embodiment is otherwise the same as that of the seat 300 of the third embodiment.

The sensors 601 may include a pressure sensor, a temperature sensor, a humidity sensor, a wakefulness sensor, a fatigue sensor, a seating sensor, a heart rate sensor, a brain wave sensor, or the like. The sensors 601 may be positioned between the front surface of the seat back pad 22 and the skin material 23. The sensors 601 may also be positioned between the front surface of the headrest pad 63 and the skin material 64.

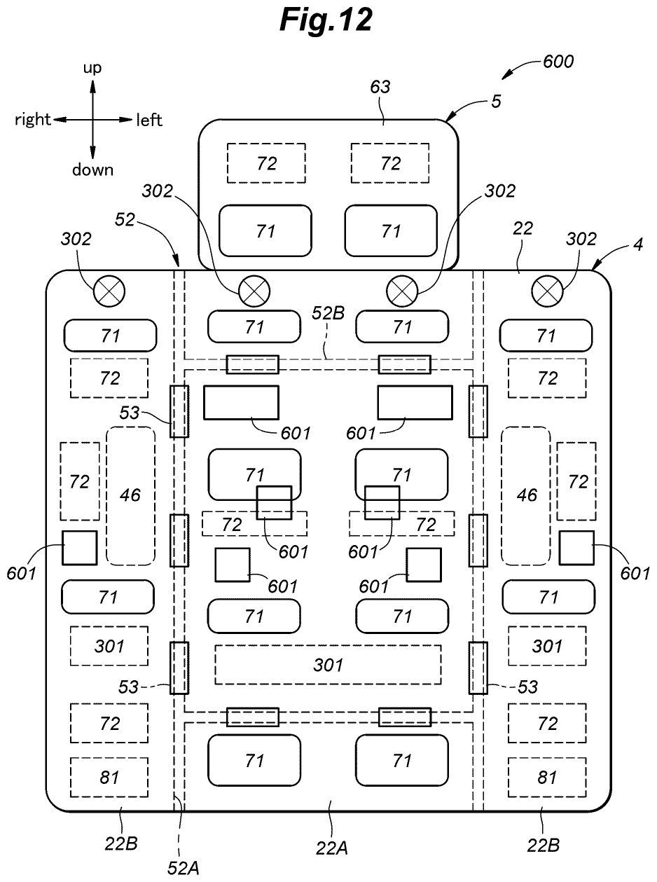

As shown in FIG. 12, the sensors 601 are positioned so as not to overlap with the vibrators 72 and the air cells 71 when viewed from the front. At least one of the sensors 601 is positioned on the front surface of each of the left and right side support parts 22B. The vibrators 72, the air cells 71, and the sensors 601 are arranged vertically spaced from one another.

The sensors 601 may be arranged around the engaging portions 53. The sensors 601 may be arranged along any one of the locking grooves 52. Some of the sensors 601 may be arranged around the intersections 52C between the longitudinal locking grooves 52A and the lateral locking grooves 52B. The sensor 601, the air cell 71, and the vibrator 72 may be arranged in this order from the top along one of the longitudinal locking grooves 52A below one of the lateral locking grooves 52B.

One of the side members of the seat back 4 may be provided with a side airbag unit 605. In this case, the sensors 601, the vibrators 72, and the air cells 71 may be arranged so as not to overlap with the side airbag unit 605 when viewed from the front. In other embodiments, the sensors 601, the vibrators 72, and the air cells 71 may overlap with the side airbag unit 605 when viewed from the front.

In other embodiments, the sensors 601 may be arranged so as to overlap with at least one of the vibrators 72 and the air cells 71 when viewed from the front.

### Seventh Embodiment

The seat 700 according to a seventh embodiment of the present invention differs from the seat 1 of the first embodiment in the arrangement of the vibrators 72 and the air cells 71. The configuration of the seat 700 of the seventh embodiment is otherwise the same as that of the seat 1 of the first embodiment.

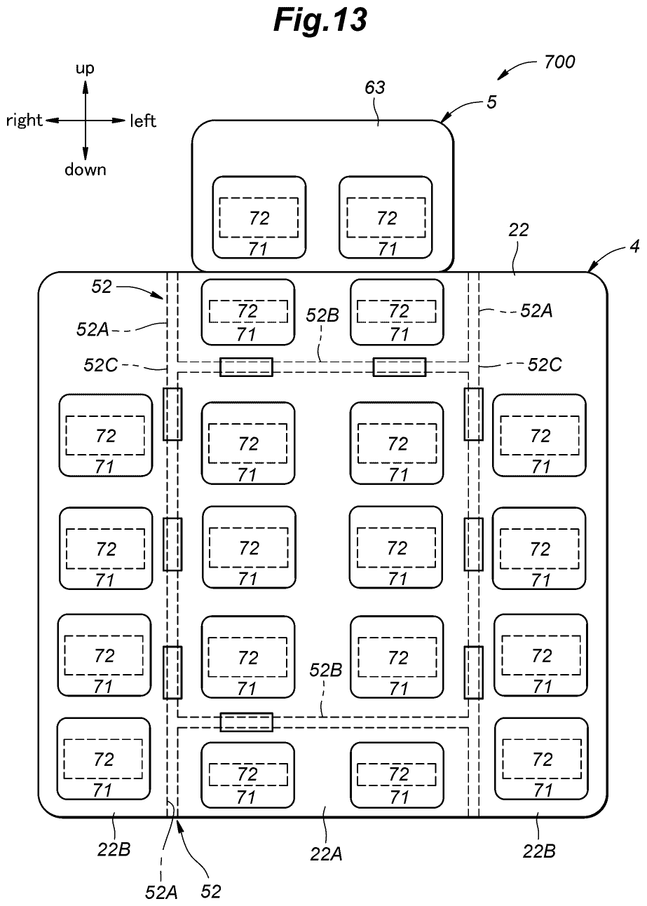

As shown in FIG. 13, when viewed from the front, each vibrator 72 overlaps with the corresponding air cell 71. More specifically, when viewed from the front, each vibrator 72 is positioned so as to entirely overlap with the corresponding air cell 71. In particular, when viewed from the front, each vibrator 72 is preferably positioned at the center of the corresponding air cell 71. Also, when viewed from the front, the center of each vibrator 72 and the center of the corresponding air cell 71 preferably coincide with each other. According to this embodiment, when each air cell 71 is inflated, the corresponding vibrator 72 is pressed against the seated occupant by the air cell 71. This promotes the transmission of the vibration of the vibrator 72 to the seated occupant.

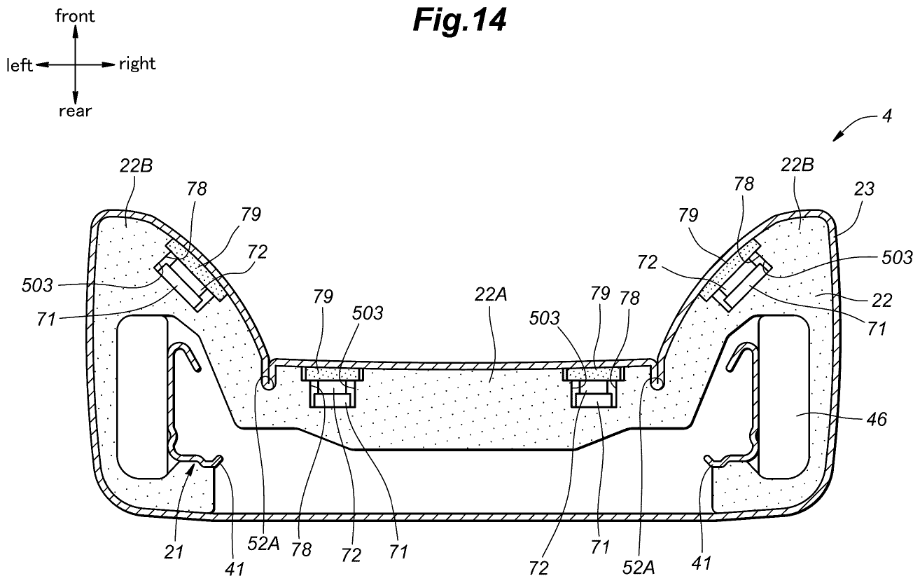

As shown in FIG. 14, a plurality of recesses 78 are formed in the central part 22A and the left and right side support parts 22B, and each air cell 71 and the corresponding vibrator 72 are preferably disposed in the corresponding recess 78 formed in the front surface of the seat back pad 22. Each air cell 71 is positioned on the bottom surface of the corresponding recess 78, and the corresponding vibrator 72 is positioned on the front surface of the corresponding air cell 71. The opening of each recess 78 is provided with a lid plate 79 that closes the opening of the recess 78. The lid plate 79 is flexible.

The recesses 78 may form a part of the air passages 503. In other words, the recesses 78 are communicated with one another via the air passages 503. Therefore, one can say that the air cells 71 and the vibrators 72 are provided in the air passages 503.

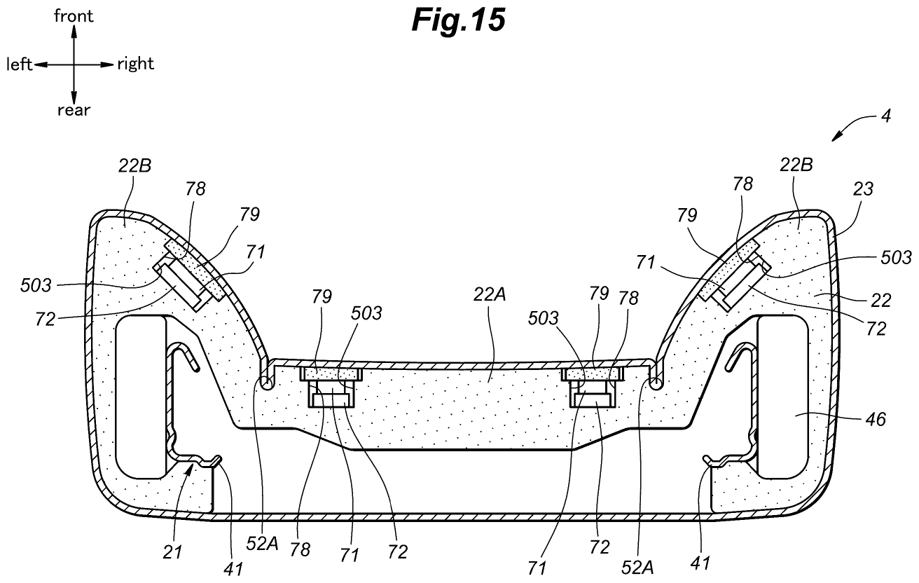

As shown in FIG. 15, in another embodiment, each vibrator 72 may be positioned on the bottom surface of the corresponding recess 78, and the corresponding air cell 71 may be positioned in front of the vibrator 72. According to this embodiment, the vibration of each vibrator 72 is transmitted to the seated occupant via the corresponding air cell 71. Therefore, the strength of the vibration transmitted to the seated occupant can be changed depending on the state of inflation of the air cells 71.

### Eighth Embodiment

The seat 800 according to an eighth embodiment of the present invention differs from the seat 700 of the seventh embodiment in the arrangement of the vibrators 72 and the air cells 71. The configuration of the seat 800 of the eighth embodiment is otherwise the same as that of the seat 700 of the seventh embodiment.

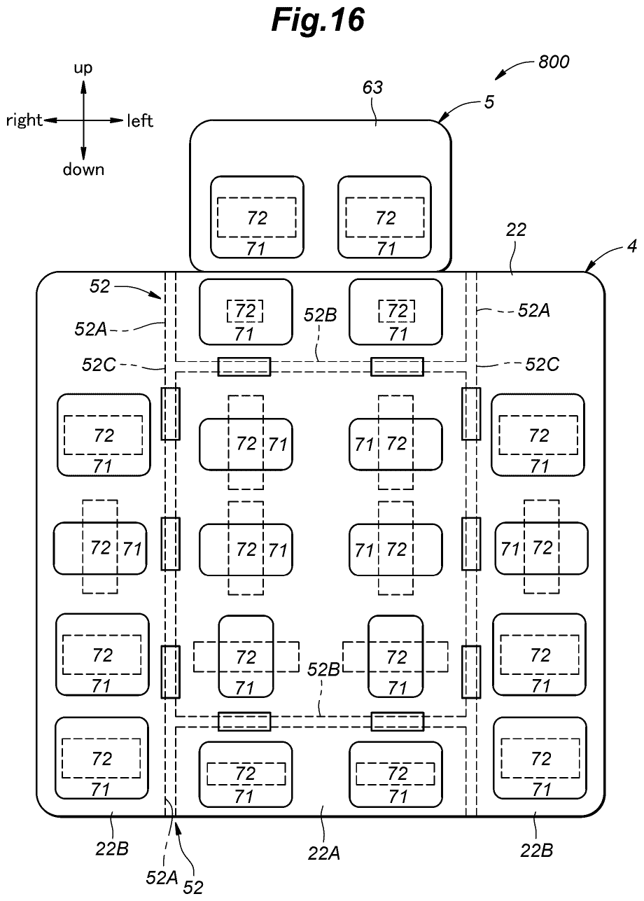

As shown in FIG. 16, a part of each vibrator 72 may protrude outward from the corresponding air cell 71 when viewed from the front. In other words, a part of each vibrator 72 may not overlap with the corresponding air cell 71 when viewed from the front. The length of the vibrator 72 in the lateral direction may be greater than the length of the corresponding air cell 71 in the lateral direction. The length of the vibrator 72 in the vertical direction may be greater than the length of the corresponding air cell 71 in the vertical direction. According to this aspect, the vibrators 72 can be made larger so that the vibration transmitted from the vibrators 72 can be more efficiently transmitted to the seated person.

### Ninth Embodiment

The seat 900 according to a ninth embodiment of the present invention differs from the seat 700 of the seventh embodiment in that the seat 900 is provided with air conditioning devices 501. The configuration of the seat 900 of the ninth embodiment is otherwise the same as that of the seat 700 of the seventh embodiment.

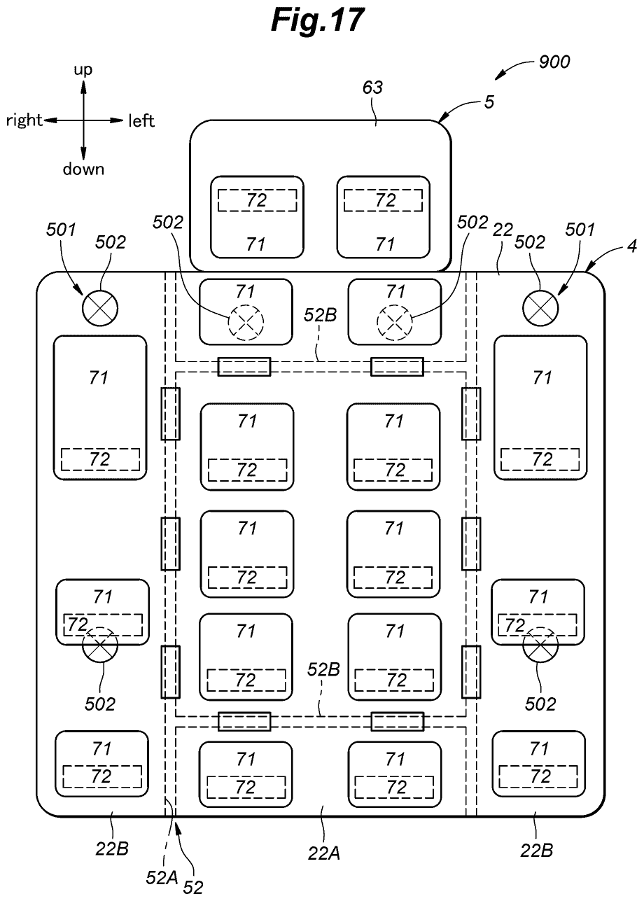

As shown in FIG. 17, each air conditioning device 501 may overlap with at least one of the vibrators 72 and the air cells 71 when viewed from the front. In particular, the blower 502 of each air conditioning device 501 may overlap with at least one of the vibrators 72 and the air cells 71 when viewed from the front.

The present invention has been described in terms of specific embodiments thereof, but is not limited to the above embodiments, and can be modified and implemented in a wide range of ways. The above embodiments were directed to seat backs 4, but the present invention is applicable to seat cushions 3 as well. Similarly to the seat backs 4 described above, the seat cushions 3 may be provided with vibrators 72, air cells 71, sensors 601, and an air conditioning device 501. The arrangement of the vibrators 72, the air cells 71, the sensors 601, and the air conditioning device 501 in the seat cushion 3 may be the same as that of the seat back 4. The fore and aft direction of the seat back 4 corresponds to the vertical direction of the seat cushion 3.

The sensors 601 may function as an input device that accepts input operations from a seated person. The seat 1 may be configured to move forward and backward, rotate around a vertical axis, recline, and perform other operations in response to input from the sensors 601. When the seat 1 is in operation and there is a possibility that the seat 1 may come into contact with another object, the operation of the vibrators 72, the air cells 71, and the air conditioning device 501 may be restricted.

The seat 1 may be provided with a table. The table may be provided so as to be movable between a storage position and a use position with respect to the seat cushion 3. When the table is in the use position, the operation of the vibrators 72, the air cells 71, and the air conditioning device 501 may be restricted.

When a child seat is attached to the seat 1, the operation of the vibrators 72, the air cells 71, and the air conditioning device 501 may be restricted. Whether or not a child seat is attached to the seat 1 may be determined by a signal from the sensors 601.

LIST OF REFERENCE NUMERALS

| | |
|---|---|
| 1, 200, 300, 400, 500, 600, | |
| 700, 800, 900: seat | |
| 2: floor | 3: seat cushion |
| 4: seat back | 5: headrest |
| 21: seat back frame | 22: seat back pad |
| 22A: central part | 22B: side support part |
| 23: skin material | 46: side airbag unit |
| 52: locking groove | 52A: longitudinal locking groove |
| 52B: lateral locking groove | 52C: intersections |
| 53: engaging portion | 71: air cell |
| 72: vibrator | 78: recess |
| 81: control device | 301: heater |
| 302: speaker | 501: air conditioning device |
| 502: blower | 503: air passage |
| 504: air opening | 601: sensor |
| 605: side airbag unit | |

1. A vehicle seat, comprising
a seat cushion and a seat back extending upward from a rear part of the seat cushion,
the seat back comprising a frame forming a skeletal structure, a pad supported by the frame, a skin material covering the pad, and a plurality of air cells and a plurality of vibrators provided on the pad,
wherein the pad includes a lateral central part and a pair of side support parts protruding forward from either side end of the central part, and
wherein some of the vibrators and some of the air cells are placed on front surfaces of the left and right side support parts such that the air cells are vertically displaced from the vibrators.

2. The vehicle seat according to claim 1, wherein an electronic control device that controls the vibrators is positioned behind a lower end part of at least one of the left and right side support parts.

3. The vehicle seat according to claim 1, wherein a plurality of sensors is provided between a front surface of the pad and the skin material, the front surfaces of the left and right side support parts being each provided with at least one of the sensors, and the vibrators, the air cells, and the sensor are vertically spaced from one another.

4. The vehicle seat according to claim 3, wherein a headrest is provided at an upper end of the seat back, and at least one of the vibrators, at least one of the air cells, and at least one of the sensors are provided in a front part of the headrest.

5. The vehicle seat according to claim 3, wherein the skin material is secured to a front surface the pad by a plurality of engaging portions, and the sensors are positioned adjacent to the engaging portions.

6. The vehicle seat according to claim 5, wherein the pad is provided with a plurality of locking grooves for pulling the skin material therein on a front surface thereof, the engaging portions are positioned within the locking grooves, and the sensors are positioned along at least one of the locking grooves.

7. The vehicle seat according to claim 6, wherein the locking grooves include a plurality of longitudinal locking grooves extending in a vertical direction and a plurality of lateral locking grooves extending in a horizontal direction, and at least some of the sensors are positioned adjacent to intersections of the longitudinal locking groove and the lateral locking grooves.

8. The vehicle seat according to claim 7, wherein the sensors, the air cells, and the vibrators are arranged in this order from top along one of the longitudinal locking grooves under one of the lateral locking grooves.

9. The vehicle seat according to claim 1, wherein the air cells are each formed in an annular shape and provided with a central hole in which the corresponding vibrator is located.

10. A method for manufacturing a vehicle seat having a seat cushion and a seat back, the method comprising the steps of:
causing a pad to be supported on a frame of the seat back;
positioning a plurality of air cells and a plurality of vibrators on a front surface of the pad such that the vibrators and the air cells do not overlap with one another when viewed from front, and
covering the pad with a skin material.
